(19) United States
(12) Patent Application Publication
(10) Pub. No.: US 2008/0113658 A1
(43) Pub. Date: May 15, 2008

(54) PORTABLE COMMUNICATION DEVICE AND METHOD FOR CREATING WISHLIST

(75) Inventors: L. Scott Bloebaum, Cary, NC (US); David S. Cronstrom, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/559,190

(22) Filed: Nov. 13, 2006

(51) Int. Cl. H04M 3/42

(52) U.S. Cl. 455/418

(57) ABSTRACT

A portable communication device is equipped to create and manage a wishlist database by wirelessly receiving product information from a tag associated with a product and storing the received product information in a wishlist database associated with the portable communication device. The wishlist database may be shared with third parties for evaluation of items or products stored within the wishlist database or the wishlist database may be transmitted to third parties to indicate items desired by the user of the portable communication device.

### TECHNICAL FIELD OF THE INVENTION

The present invention relates generally to portable communication devices, and, more particularly, to a portable communication device and method for creating and managing a wishlist database.

### DESCRIPTION OF RELATED ART

In recent years, portable communication devices, such as mobile phones, personal digital assistants, mobile terminals, etc., continue to grow in popularity. As the popularity of portable communication devices continues to grow, today's wireless landscape is rapidly changing as mobile phones and networks are being enhanced to provide features and services beyond voice communications. The wireless industry is experiencing a rapid expansion of mobile data services. In addition, the features associated with certain types of portable communication devices have become increasingly diverse. To name a few examples, many portable communication devices have cameras, text messaging capability, Internet browsing functionality, electronic mail capability, video playback capability, audio playback capability, image display capability, position sensing capability and hands-free headset interfaces.

As portable communication devices continue to evolve in terms of functionality, users increasingly rely on the convenience associated with their portable communication devices for daily activities such as taking photos, scheduling meetings, Internet browsing, accessing email accounts and the like. Given the wide range of functionality available with today's portable communication devices, there is a trend to maximize the number of uses for portable communication devices.

### SUMMARY

In view of the foregoing, a need exists for additional mobile data services, and application programs for providing additional mobile data services, such as application programs that facilitate using a portable communication device for commercial transactions, such as creating and managing a database or list of items under purchase consideration or desired by the user of the device (a “wishlist database.”)

One aspect of the technology relates to portable communication device including a memory, a localized communicator, and a controller coupled to the memory and the localized communicator, wherein the controller executes a program stored on a machine-readable medium. When the program is loaded in memory in the portable communication device and executed, the program causes the portable communication device to wirelessly receive via the localized communicator product information from a tag associated with a product, and store the received product information in a wishlist database associated with the portable communication device.

According to another aspect, the portable communication device includes a display, and the program causes the portable communication device to present product information within the wishlist database for viewing on the display.

According to another aspect, the program causes the portable communication device to transmit the wishlist database to a third party.

According to another aspect, the program causes the portable communication device to transmit the wishlist database to a third party via an email message.

According to another aspect, the wirelessly received product information comprises a file stored on the tag, where the file include a Uniform Resource Locator (URL) indicative of an Internet address where the product information is accessible by the portable communication device.

According to another aspect, the file is stored on the tag is an Extensible Markup Language (XML) file.

According to another aspect, the wirelessly received product information includes a product-promotion URL indicative of an Internet address where product promotion information is accessible by the portable communication device.

According to another aspect, the file includes at least one image file representative of the product.

According to another aspect, the at least one image file is a thumbnail image file.

According to another aspect, the file includes a plurality of Uniform Resource Locators (URLs), with each URL being indicative of an Internet address where product information for a product variant is accessible by the portable communication device.

According to another aspect, the file includes a plurality of image files, where respective image files are linked to respective URLs for various product variants.

According to another aspect, the localized communicator is a near-field communications (NFC) module.

According to another aspect, the portable communication device is a mobile telephone.

Another aspect of the technology relates to a method of creating a wishlist database, which is implemented on a portable communication device. The method includes wirelessly obtaining product information via the portable communication device, assembling the obtained product information in a product information folder, and creating a wishlist database of product information folders.

According to another aspect, the method includes storing the wishlist database in a memory of the portable communication device.

According to another aspect, the method includes transmitting the wishlist database to a remote location for storage, wherein the wishlist database is accessible via the Internet.

According to another aspect, wirelessly obtaining product information includes capturing image data representative of a product.

According to another aspect, wirelessly obtaining product information includes wirelessly receiving product information from a tag associated with a product.

According to another aspect, the wirelessly received product information includes a file stored on the tag, the file including a Uniform Resource Locator (URL) indicative of an Internet address where the product information is accessible by the portable communication device.

According to another aspect, the file stored on the tag is an Extensible Markup Language (XML) file.

Another aspect of the technology relates to a method of creating a wishlist database, which is implemented on a portable communication device. The method includes wirelessly receiving via a localized communicator product information from a tag associated with a product, and storing the received product information in a wishlist database associated with the portable communication device.

According to another aspect, the wirelessly received product information includes a file stored on the tag, the file including a Uniform Resource Locator (URL) indicative of an Internet address where the product information is accessible by the portable communication device.

According to another aspect, the file stored on the tag is an Extensible Markup Language (XML) file.

According to another aspect, the XML file includes a product-promotion URL indicative of an Internet address where product promotion information is accessible by the portable communication device.

According to another aspect, the XML file includes at least one image file representative of the product.

According to another aspect, the XML file includes a plurality of Uniform Resource Locators (URLs), with each URL being indicative of an Internet address where product information for a product variant is accessible by the portable communication device.

According to another aspect, the XML file includes a plurality of image files, where respective image files are linked to respective URLs for various product variants.

According to another aspect, the method includes presenting product information within the wishlist database for viewing on a display of the portable communication device.

According to another aspect, the method includes transmitting the wishlist database to a remote location.

According to another aspect, the method includes transmitting the wishlist database to a third party via an email message.

Another aspect of the technology relates to a method of managing product information that includes associating a tag with a product, the tag being wirelessly readable by a localized communicator associated with a portable communication device, programming the tag with product information, the tag including an Extensible Markup Language (XML) file containing at least one Uniform Resource Locator (URL) indicative of an Internet address where the product information is accessible.

According to another aspect, the tag includes at least one image file representative of the product.

According to another aspect, the tag includes at least one product-promotion URL indicative of an Internet address where product promotion information is accessible.

According to another aspect, the method includes updating product information associated with the product information URL and/or updating product promotion information associated with the product-promotion URL.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of a mobile telephone as an exemplary portable communication device;

FIG. 2 is a diagrammatic illustration of a communications system including a portable communication device on which aspects of the technology may be carried out;

FIG. 3 is a diagrammatic illustration of a portable communication device in accordance with aspects of the present technology;

FIG. 4 is a diagrammatic illustration of a portable communication device in proximity to a product associated with a product information tag;

FIG. 5 is a flow chart or functional diagram representing a method of creating a wishlist database using a portable communication device; and

FIG. 6 is a flow chart or functional diagram representing an alternative embodiment of a method of creating a wishlist database using a portable communication device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As used herein, the term “portable communication device” includes portable radio communication equipment. The term “portable radio communication equipment”, which herein after may be referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used for voice and/or data communication, e.g., a near-field communications (NFC)-enabled communication device.

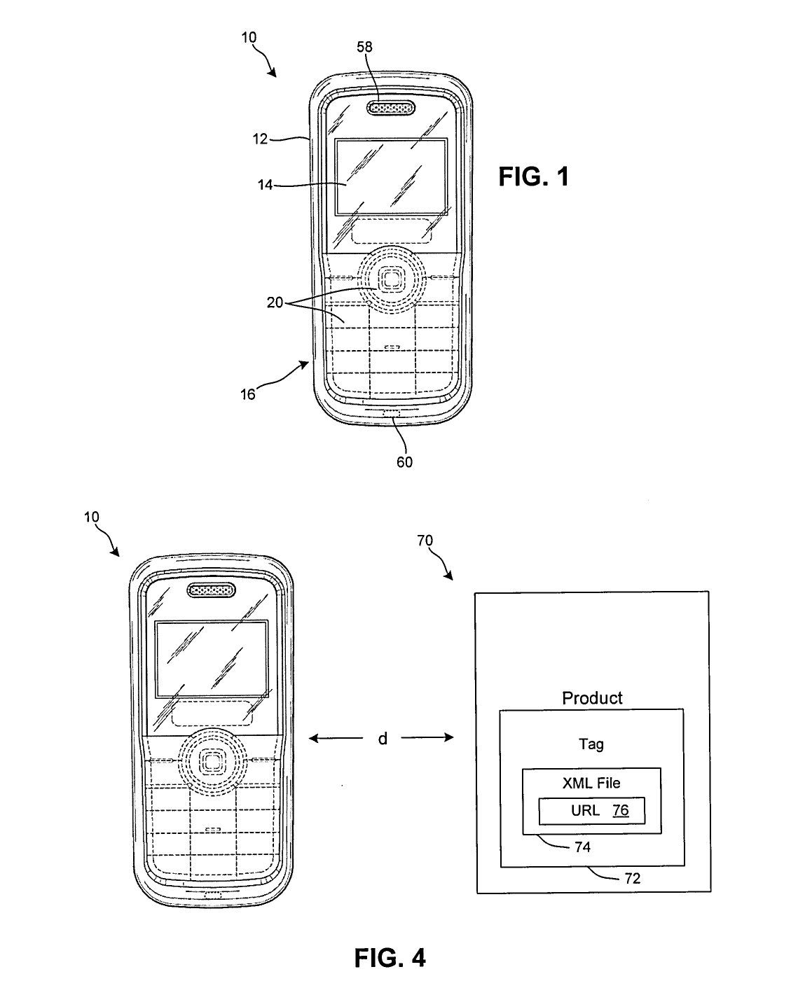

Referring initially to FIGS. 1-3, an exemplary embodiment of a portable communication device 10 (e.g., a mobile phone, mobile terminal or the like) is depicted. As is described more fully below, the portable communication device 10 includes a wishlist application (e.g., an application program, code or logic routine that is executed by the portable communication device) and a localized communicator (e.g., a near-field communication (NFC) module that enables wireless receipt of product information from a tag associated with a product. The portable communication device 10 is equipped to create and manage a wishlist database.

The portable communication device in the illustrated embodiments is a mobile telephone, and may be referred to as the mobile telephone 10. As indicated, the description and illustrations of a mobile telephone for the portable communication device are intended to serve as a non-limiting exemplary environment for the inventive concepts described herein. The mobile telephone 10 is shown as having a “brick” or “block” form factor housing 12, but it will be appreciated that other types of housings, such as a clamshell housing or a slide-housing, may be utilized.

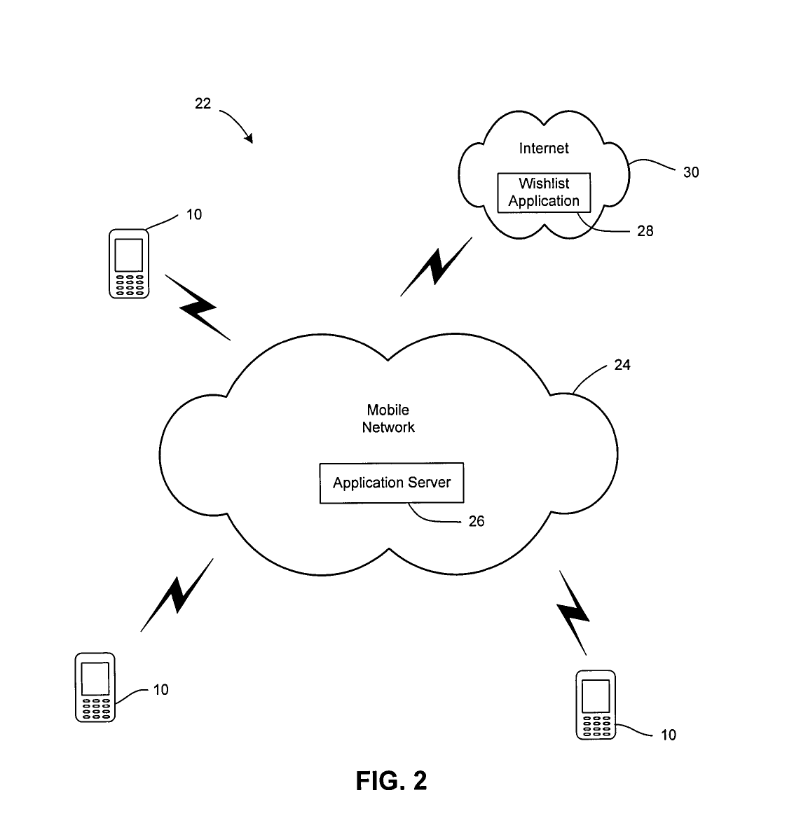

The mobile telephone 10 includes a display 14 and keypad 16. As is conventional, the display 14 displays information to a user, such as operating state, time, telephone numbers, contact information, various navigational menus and the like, which enable the user to utilize the various features of the mobile telephone 10. The display 14 also may be used to visually display content received by the mobile telephone 10 and/or retrieved from a memory 32 (FIG. 2) of the mobile telephone 10.

Similarly, the keypad 16 may be conventional in that it provides for a variety of user input operations. For example, the keypad 16 typically includes alphanumeric keys 20 for facilitating entry of alphanumeric information, such as telephone numbers, phone lists, contact information, notes and the like. In addition, the keypad 16 typically includes special function keys, such as a “call send” key for initiating or answering a call, and a “call end” key for ending or “hanging up” a call. Special function keys also may include menu navigation keys, for example, for navigating through a menu displayed on the display to select different telephone functions, profiles, settings, etc., as is conventional. Other keys associated with the mobile telephone may include a volume key, an audio mute key, an on/off power key, a web browser launch key, a camera key and the like. Keys or key-like functionality also may be embodied as a touch screen associated with the display 14. While some embodiments of the search application may not involve keypad-based user interaction with the mobile telephone 10, other embodiments may include keypad interaction with the search application, such as entering search query, setting up various other options, data selection and the like.

The mobile telephone 10 includes conventional call circuitry that enables the mobile telephone 10 to establish a call or otherwise exchange signals with a call/calling device, typically another mobile telephone, landline telephone or other electronic device. However, the call/calling device need not be another telephone, but may be some other device, such as an Internet web server, media server or the like. The call circuitry also may be responsible for transmitting text messages that are prepared by the user.

Turning now to FIG. 2, the portable communication device 10 may be configured to operate as part of a communication system 22. The communication system includes a mobile network 24, such as a mobile cellular telephony network, that facilitates communication, such as voice communication and/or data transfer between a plurality of portable communication devices 10, such as mobile phones, mobile terminals or the like. The mobile network 24 includes a server 26 (or servers) for managing calls placed by and destined to the portable communication device 10, as well as supporting one or more applications (e.g., a wishlist application) by (e.g., including appropriate hardware and/or application programs for creation and management of wishlist database). For purposes of the discussion contained herein, portable communication device 10 will be described in terms of creating and managing a wishlist database of product information corresponding to products that may be desired or under purchase consideration by a user of the portable communication device (also referred to simply as “user”). In accordance with at least one embodiment, the portable communication device, which creates the wishlist database, shares or otherwise transmits the wishlist database to one or more other portable communication devices or some other remote device or system (e.g., a wishlist application server 28 accessible via the Internet 30.)

It will be appreciated that the mobile network 24 includes a network infrastructure, portions of which are used or otherwise accessed by the portable communication devices. The portable communication devices 10 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system shown in FIG. 2 is provided for purposes of explaining aspects of the present invention, without limiting the invention to a particular communication system design, architecture or communication standard.

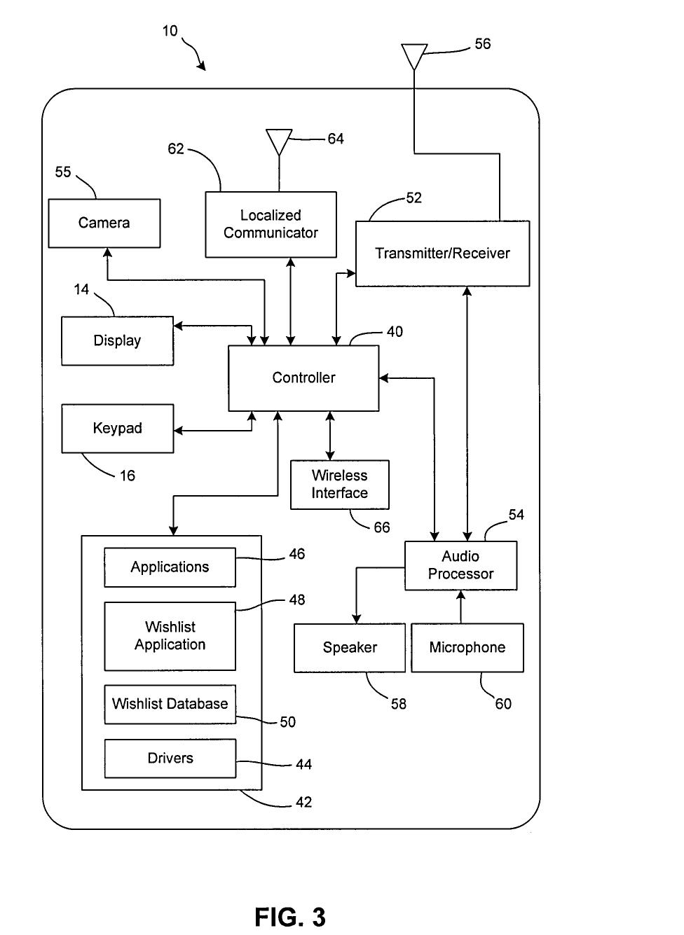

FIG. 3 represents a functional block diagram of a portable communication device 10. The portable communication device 10 includes a controller 40 that controls the overall operation of the portable communication device. The controller 40 may include any commercially available or custom microprocessor or microcontroller. Memory 42 is operatively connected to the controller 40 for storing control programs and data used by the portable communication device. The memory 42 is representative of the overall hierarchy of memory devices containing software and data used to implement the functionality of the portable communication device in accordance with one or more aspects described herein. The memory 42 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 42 stores drivers 34 (e.g., I/O device drivers), application programs 46, including a wishlist application program 48, and application program data (e.g., a wishlist database 50). The I/O device drivers include software routines that are accessed through the controller 40 (or by an operating system (not shown) stored in memory 42) by the application programs, including the wishlist application program 48, to communicate with devices such as the display 14 and other input/output ports.

The application programs, including the wishlist application program 48, comprise programs that implement various features of the portable communication device 10, such as voice calls, e-mail, Internet access, contact manager and the like. As is described more fully below, the wishlist application program 48 comprises a program, logic routine or code that enables the user to create and/or manage a wishlist database of product information representative of or otherwise corresponding to one or more products that may be desired by the user.

A person having ordinary skill in the art of computer programming, and specifically in applications programming for mobile phones, will consider it obvious in view of the description provided herein how to program a mobile phone to operate and carry out the functions described herein with respect to the wishlist application 48 (and any interfacing between the wishlist application program 48 and other application programs (e.g., messaging application programs, media application programs and the like). Accordingly, details as to the specific programming code have been left out. Also, while the search functionality is carried out via the controller 40 and wishlist application 48 (alone or in conjunction with other application programs) in memory 42 in accordance with inventive aspects, such function also could be carried out via dedicated hardware, firmware, software or combinations thereof without departing from the scope of the present invention.

With continued reference to FIG. 3, the controller 40 interfaces with the aforementioned display 14 and keypad 16 (and any other user interface device), a transmitter/receiver 52 (often referred to as a transceiver), audio processing circuitry, such as an audio processor 54, and a position determination element (not shown), such as a global positioning system (GPS) receiver. The portable communication device 10 may include a camera 55 that captures digital pictures and/or video. Image and/or video files corresponding to the pictures and/or video may be stored in memory 42 (e.g., within the wishlist database 50 if the pictures are representative of product information).

An antenna 56 is coupled to the transmitter/receiver 52 such that the transmitter/receiver 52 transmits and receives signals via antenna 56, as is conventional. The portable communication device includes an audio processor 54 for processing the audio signals transmitted by and received from the transmitter/receiver. Coupled to the audio processor 54 are a speaker 58 and microphone 60, which enable a user to listen and speak via the portable communication device. Audio data may be passed to the audio processor 54 for playback to the user. The audio data may include, for example, audio data from an audio file stored in the memory 42 and retrieved by the controller 40. The audio processor 54 may include any appropriate buffers, decoders, amplifiers and the like.

In the illustrated embodiment, the portable communication device 10 also includes a localized communicator 62 (e.g., a near-field communication (NFC) module 62, which also may be referred to as an NFC chipset, an NFC transceiver, an NFC interface, an NFC adaptor or the like) or other comparable communication components (e.g., a close-proximity data transceiver) to establish a localized communication link with a compatible (e.g., readable) component (e.g., a tag or transponder programmed with or otherwise storing product information regarding a product with which the tag is associated) when the localized communicator is in relatively close proximity to the tag. It will be appreciated that the term “tag” may include a passive tag (e.g., a passive RFID-type tag), as well as an active tag (e.g., an active transceiver operable to either emulate a passive tag (receive only) or engage in bi-directional peer-wise communication with a compatible device).

The term NFC generally is used to refer to a magnetic-field induction communication interface and protocol (e.g., the communication interface and protocol that was jointly developed by Sony and Phillips and which has been adopted as standard by ECMA (ECMA-340) and ISO/IEC (ISO/IEC 18092). The NFC module 62 is coupled to or otherwise includes a coupler 64 (e.g., a NFC coupler including an inductor or coil in the form of an antenna). NFC generally has a working distance of about 0 centimeters to several tens of centimeters (or more). NFC may be used in a passive communication mode where an initiator device provides a carrier field and that is answered by modulating the existing field with a transponder, which may draw operating power from the initiator-provided electromagnetic field. NFC also may be used in an active communication mode where both the initiator and transponder communicates by generating their own fields in, in which case, both the initiator and transponder typically receive power from a power supply. NFC may be used to configure and initiate another wireless network connection or interface between devices, such as Bluetooth and WiFi connections.

As will be appreciated, the illustration and description of a localized communicator 62 or NFC module 62 is meant to be an example of a close-proximity communication device and any appropriate device to establish a localized communication link may be used and may include devices that rely on a capacitive coupling technique, a propagating wave, e.g., electromagnetic, technique, a radio frequency transmission technique, e.g., such as the techniques used for RF identification (RFID) devices, a magnetic field induction technique or any other appropriate techniques.

The portable communication device also may include one or more local wireless interfaces (indicated generally as wireless interface 66), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 66 may be representative of an interface suitable for communication within a cellular network or other wireless wide-area network (WWAN). As will be appreciated, the local wireless interface 66 may be used to transmit data, e.g., a wishlist database created by the portable communication device 10.

With reference now to FIG. 4, aspects of the method, device and system described herein will be described with respect to a portable communication device 10 that creates and/or manages a wishlist database. In accordance with one exemplary embodiment, the portable communication device receives or otherwise obtains product information from a tag 72 (e.g., a transponder or RFID tag) when the portable communication device 10 is in proximity to the product 70 (or at least to the tag 72 associated with the product 70). The product 70 includes a tag 72 or other information storage component (e.g., an NFC-readable tag) that is capable of being “read” by the localized communicator 62 (e.g., an NFC module) associated with the portable communication device. While the method, device and system are being described with respect to an NFC communication link between the portable communication device 10 and the tag 72 associated with the product 70, it will be appreciated that one or more other wireless interfaces or communication links may be used to obtain or otherwise receive data stored on the tag 72 associated with the product 70. As is discussed more fully below, the tag 72 may be programmed with one or more XML (Extensible Markup Language) files 74 that contain one or more product-related Uniform Resource Locators URLs 76 (e.g., one or more product information URLs and/or one or more product-promotion URLs). One of ordinary skill in the art will appreciated that text-based or binary file formats other than XML may be used to organize and convey product information.

As one of ordinary skill in the art also will appreciate, NFC means and includes communication that can be accomplished when the portable communication device 10 and the tag 72 are “in proximity” or “in relative proximity,” e.g., within a distance “d” of one another, where distance “d” is between 0 centimeters and several tens of centimeters (including when the housing of the portable communication device 10 is in contact with the tag 72).

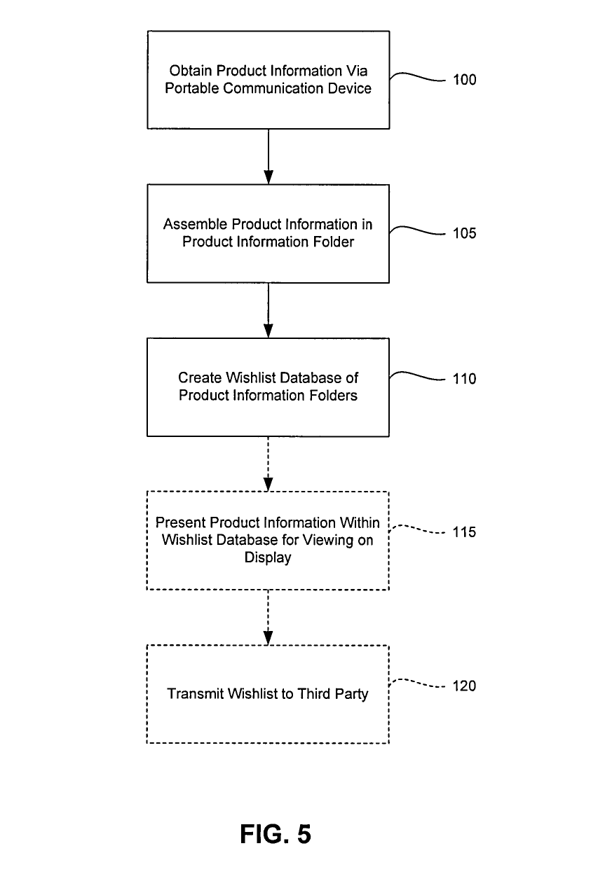

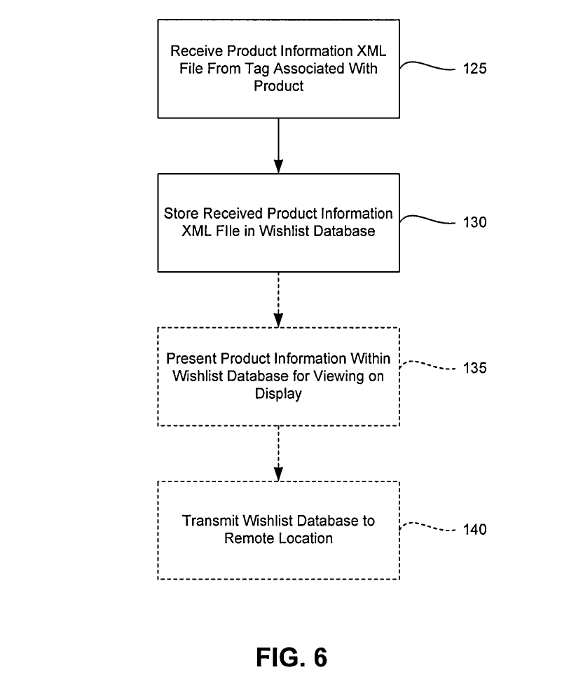

While for purposes of simplicity of explanation, the flow charts or diagrams in FIGS. 5-6 include a series of steps or functional blocks that represent one or more aspects of the relevant operation of the portable communication device 10. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

The methodologies illustrated in FIGS. 5-6, which are implemented on or through a portable communication device, relate to creating and/or managing a wishlist database that includes or otherwise is representative of product information corresponding to one or more items or products that may be desired by a user of the portable communication device. Turning now to FIG. 5, a method of creating and/or managing a wishlist database begins at functional block 100 where the portable communication device obtains product information regarding a product that may be desired by the user. In one embodiment, obtaining product information includes the portable communication device capturing image data (e.g., a photo) of a product or item that may be desired by the user. In addition or alternatively, obtaining product information may include downloading or otherwise wirelessly receiving product information from a tag (e.g., a NFC-readable tag, an RFID tag or the like) that is associated with a product potentially desired by the user. It will be appreciated that the tag may include a variety of information or data relating to the product with which the tag is associated, including, but not limited to, product name, brand name, manufacturer's name, available sizes, color variants, available styles or models, retail price, sale prices, and other promotions associated with the given product.

While aspects of the herein described method and device are being discussed with respect to a tag (e.g., an RFID tag or badge) being associated with individual products, such as being part of a label placed on or adjacent the given product, it will be appreciated that product information may be stored on a NFC-readable tag or badge associated with a display of multiple products. For example, a single tag may be associated with a rack of shirts or with various shelves of pants or other products such that a single tag-containing label need not be applied to each individual product or item. In another alternative embodiment, the tags may be incorporated into a catalog, which is representative of, but separate from, actual products. This embodiment may find practical application in connection with making selections for a bridal or baby registry. It will be appreciated that functional block 100 may be implemented in a number of ways depending on the functionality associated with the portable communication device that is obtaining the product information. For example, the portable communication device may include other wireless data receipt modules, including, but not limited to Bluetooth, an optical scanner (e.g., a barcode scanner) or the like.

At functional block 105, the obtained or received product information is assembled, organized or otherwise correlated (e.g., in a product information file or folder). For example, in one exemplary embodiment where various items of product information are obtained (e.g., a photo of the product as well as various product information data wirelessly received from a tag associated with the product) the various product information can be assembled or otherwise linked together such that a user may access or otherwise view a product information summary, which may include one or more photos in connection with various product information. It will be appreciated that functional blocks 100 and 105 may be repeated as a user engages in a shopping trip viewing and obtaining product information regarding a variety of various products.

At functional block 110, the portable communication device creates a wishlist database made up of one or more product information folders, files or groupings of product information. The wishlist database may be structured using any suitable database structure or hierarchy to facilitate organization and presentation of product information to a user or third party. In addition, the wishlist database may be structured, indexed, or otherwise categorized in one of a number of ways. If the user is engaging in a large shopping trip or multiple shopping trips in which various types or categories of items or products are viewed, the wishlist database may be structured or otherwise organized based on the types or categories of products viewed. For example, if the user engages in a shopping trip in which clothing items are viewed along with electronic items, the wishlist database may be indexed or otherwise categorized based on clothing items (e.g., including various types of shirts, pants, shoes or the like) as well as electronic items (e.g., categorized by computer items, television items, mobile phones or the like).

Optionally, at functional block 115, the portable communication device may present the product information within the wishlist database for viewing on a display associated with the portable communication device. For example, once the user is finished with his or her shopping trip and has created a suitable wishlist database in the portable communication device, the portable communication device may present the items within the wishlist database for viewing by the user of the portable communication device alone or together with third parties. For example, if the user is undecided between one of a number of items (e.g., types of shirts or types of pants) the user may display the information stored within the wishlist database for viewing by a friend or significant other so that the friend or significant other may help the user decide on which item to purchase.

Optionally, at functional block 120, the portable communication device may transmit the wishlist database to a remote location or to a remote user. For example, the user may desire that the wishlist database be sent to others and used as a suggestion for purchase of a gift for an upcoming special event, such as a birthday, anniversary, wedding, holiday or the like. Transmitting the wishlist database may include sending the database (or one or more product information items stored within the wishlist database) to a user via an e-mail or other suitable message format. Alternatively, the wishlist database (or one or more product information items within the wishlist database) may be transmitted (e.g., via the Internet) to a website representative of the user's wishlist database, where others may access the user's wishlist database (e.g., to receive ideas on items that the user may desire for a gift).

Referring now to FIG. 6, a method of creating a wishlist database including product information corresponding to or representative of one or more items or products, which may be desired by a user of a portable communication device, begins at functional block 125 where the portable communication device downloads or otherwise receives product information from a tag (e.g., a NFC-readable tag, an RFID tag or the like) associated with a product that may be desired by the user of the portable communication device. In a preferred embodiment, the portable communication device wirelessly receives an XML (Extensible Markup Language) file stored on the tag associated with the product. As is discussed above, receipt of the product information XML file from the tag may be accomplished via any suitable localized communication link between a localized communicator within the portable communication device and the tag (e.g., a NFC communication link between an NFC module within the portable communication device and the tag associated with the product). It will be appreciated that XML is a text-based markup language that is extremely rich in terms of its capabilities to describe and apply a hierarchical structure to a wide range of information. For example, XML may be used to represent information spanning the spectrum from semi-structured information (such as one would find in a word processing document) to highly structured information (such as that which is contained in a table). XML is well-suited for many types of communication including business-to-business and client-to-server communication, as well as transferring information between different information systems.

In a preferred embodiment, the product information XML file includes a URL (Uniform Resource Locator) indicative of the location or Internet address at which the latest product information can be accessed by a user through his or her portable communication device (or other suitable electronic equipment with Internet access) after downloading the URL-containing XML file, which is stored on the tag. One advantage of this configuration resides in the fact that the latest product information (e.g., product price, brand name, style, available colors or other product variants, or the like) may be kept up to date in one place, thereby eliminating the cost of replacing tags as product characteristics change. In one embodiment, the tag also contains an actual image of the item or product (a thumbnail image or a larger image) in addition to or instead of the product information URL.

If there are multiple variants, (e.g., colors) of the item or product, which are distinguishable in an image, the tag may include one thumbnail image per product variant. In this case, each thumbnail may be linked within the XML file with a separate URL that is specific to that product variant. For example, if the product desired by the user of the portable communication device is a pair of pants that is available in four different colors, the XML may include four thumbnail images (one for each color that is available), with each thumbnail image being linked to a specific URL for that color variant. In accordance with another alternative embodiment, the XML file stored on the tag may contain an additional product-promotion URL that may be used by the user of the portable communication device to receive special offers related to the product. This product-promotion URL may be specific to the manufacturer or merchant, and may be updated dynamically over time (e.g., the user of the portable communication device may receive an alert indicating that a particular item is on sale during a given week). The XML file stored on the tag also may include a thumbnail representative of this product-promotion URL. In the embodiment where the tag includes a product-promotion URL that is downloaded or otherwise transferred to the portable communication device, the wishlist application associated with the portable communication device may be configured to periodically check for sales or other new promotional information in connection with a specific by accessing the product-promotion URL.

At functional block 130, the portable communication device stores or otherwise saves the received product information XML file in a wishlist database folder or file locally on the portable communication device. Alternatively, the portable communication device may save the product information XML file in a wishlist file or folder saved in a remote location (e.g., on a wishlist application server 28 (FIG. 1) that is accessible via the Internet). In addition or alternatively, the user may be presented with an option of sending the product information XML file, which contains one or more URLs with or without associated thumbnail images, directly to another user via an appropriate messaging application (e.g., e-mail, short message service or the like). Of course, during the creation and/or modification of the wishlist database, the user may enter input to modify the wishlist database, such as indicating that an item should be removed or that a particular variant (e.g., color of an item) is preferred prior to or after saving the product information within the wishlist database.

As is discussed above, at functional block 135, the portable communication device optionally may present the product information within the wishlist database for viewing on a display of the portable communication device. For example, the user of the portable communication device may wish to access or otherwise view product information and/or product promotion information stored within the wishlist database. At this point, the portable communication device may retrieve the various product information items, such as any or all thumbnail images or regular images associated or otherwise representative of a given product along with downloaded or accessed product information available via the URL contained within the XML file. This product information may be displayed in any of a variety of formats for viewing by a user of the portable communication device.

Optionally, at functional block 140, the portable communication device may transmit the wishlist database to a remote location, such as to a portable communication device belonging to a third party and/or to a wishlist server accessible via the Internet. Transmission of the wishlist database to a remote location allows the user to send information regarding potentially desired items to others (e.g., as suggestions for purchase of a gift).

It will be appreciated that a portable communication device having the capability of creating and/or managing a wishlist database provides the user with the capability of conveniently and efficiently creating a wishlist of items that the user of the portable communication device may desire. Further, the dynamic nature of embodying product information in an XML file containing a product-specific URL allows for dynamic updating of product information so that the latest product information may be accessed by a user any time after downloading the XML file stored on the tag. Of course, such internet-based information may be kept up to date in one place, thereby eliminating the cost of replacing tags, (e.g., tags to be incorporated and labeled placed on products) as product characteristics change. Furthermore, the inclusion of one or more product-promotion URLs within the XML file on the product information tag provide the user with the capability of receiving personalized and dynamic alerts relating to product promotions, as well as providing the manufacturer and/or seller of product to provide targeted promotional information to potential customers.

The above-described method, device and system facilitates a method of managing product information that includes associating a tag with a product, where the tag is wirelessly readable by a localized communicator associated with a portable communication device, and programming the tag with product information in the form of an Extensible Markup Language (XML) file containing at least one Uniform Resource Locator (URL) indicative of an Internet address where the product information is accessible. As is discussed above, the tag includes at least one image file representative of the product. In addition, the tag may include at least one product-promotion URL indicative of an Internet address where product promotion information is accessible. This methodology allows for dynamic updating of product information associated with the product information URL and/or dynamic updating of product promotion information associated with the product-promotion URL.

As will be appreciated by one of skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a memory;
a localized communicator;
a controller coupled to the memory and the localized communicator, wherein the controller executes a program stored on a machine-readable medium, wherein when the program is loaded in memory in the portable communication device and executed causes the portable communication device to:
wirelessly receive via the localized communicator product information from a tag associated with a product; and
store the received product information in a wishlist database associated with the portable communication device.

2. The portable communication device according to claim 1, further comprising a display, and wherein the program causes the portable communication device to present product information within the wishlist database for viewing on the display.

3. The portable communication device according to claim 1, wherein the program causes the portable communication device to transmit the wishlist database to a third party.

4. The portable communication device according to claim 3, wherein the program causes the portable communication device to transmit the wishlist database to a third party via an email message.

5. The portable communication device according to claim 1, wherein the wirelessly received product information comprises a file stored on the tag, the file including a Uniform Resource Locator (URL) indicative of an Internet address where the product information is accessible by the portable communication device.

6. The portable communication device according to claim 5, wherein the file stored on the tag is an Extensible Markup Language (XML) file.

7. The portable communication device according to claim 5, wherein the wirelessly received product information includes a product-promotion URL indicative of an Internet address where product promotion information is accessible by the portable communication device.

8. The portable communication device according to claim 5, wherein the file includes at least one image file representative of the product.

9. The portable communication device according to claim 8, wherein the at least one image file is a thumbnail image file.

10. The portable communication device according to claim 5, wherein the file includes a plurality of Uniform Resource Locators (URLs), with each URL being indicative of an Internet address where product information for a product variant is accessible by the portable communication device.

11. The portable communication device according to claim 10, wherein the file includes a plurality of image files, where respective image files are linked to respective URLs for various product variants.

12. The portable communication device according to claim 1, wherein the localized communicator is a near-field communications (NFC) module.

13. The portable communication device according to claim 10, wherein the portable communication device is a mobile telephone.

14. A method of creating a wishlist database, the method being implemented on a portable communication device, the method comprising:
wirelessly obtaining product information via the portable communication device;
assembling the obtained product information in a product information folder; and
creating a wishlist database of product information folders.

15. The method according to claim 14, further comprising:
storing the wishlist database in a memory of the portable communication device.

16. The method according to claim 14, further comprising:
transmitting the wishlist database to a remote location for storage, wherein the wishlist database is accessible via the Internet.

17. The method according to claim 14, wherein wirelessly obtaining product information includes capturing image data representative of a product.

18. The method according to claim 17, wherein wirelessly obtaining product information includes wirelessly receiving product information from a tag associated with a product.

19. The method according to claim 18, wherein the wirelessly received product information includes a file stored on the tag, the file including a Uniform Resource Locator (URL) indicative of an Internet address where the product information is accessible by the portable communication device.

20. The method according to claim 19, wherein the file stored on the tag is an Extensible Markup Language (XML) file.

21. A method of creating a wishlist database, the method being implemented on a portable communication device, the method comprising:
wirelessly receiving via a localized communicator product information from a tag associated with a product; and
storing the received product information in a wishlist database associated with the portable communication device.

22. The method according to claim 21, wherein the wirelessly received product information includes a file stored on the tag, the file including a Uniform Resource Locator (URL) indicative of an Internet address where the product information is accessible by the portable communication device.

23. The method according to claim 22, wherein the file stored on the tag is an Extensible Markup Language (XML) file.

24. The method according to claim 23, wherein the XML file includes a product-promotion URL indicative of an Internet address where product promotion information is accessible by the portable communication device.

25. The method according to claim 23, wherein the XML file includes at least one image file representative of the product.

26. The method according to claim 22, wherein the XML file includes a plurality of Uniform Resource Locators (URLs), with each URL being indicative of an Internet address where product information for a product variant is accessible by the portable communication device.

27. The method according to claim 26, wherein the XML file includes a plurality of image files, where respective image files are linked to respective URLs for various product variants.

28. The method according to claim 21, further comprising presenting product information within the wishlist database for viewing on a display of the portable communication device.

29. The method according to claim 21, further comprising transmitting the wishlist database to a remote location.

30. The method according to claim 21, further comprising transmitting the wishlist database to a third party via an email message.

31. A method of managing product information, the method comprising:
associating a tag with a product, the tag being wirelessly readable by a localized communicator associated with a portable communication device;
programming the tag with product information, the tag including an Extensible Markup Language (XML) file containing at least one Uniform Resource Locator (URL) indicative of an Internet address where the product information is accessible.

32. The method according to claim 31, wherein the tag includes at least one image file representative of the product.

33. The method according to claim 32, wherein the tag includes at least one product-promotion URL indicative of an Internet address where product promotion information is accessible.

34. The method according to claim 32, further comprising updating product information associated with the product information URL and/or updating product promotion information associated with the product-promotion URL.
